(19) United States
(12) Patent Application Publication
(10) Pub. No.: US 2006/0045633 A1
(43) Pub. Date: Mar. 2, 2006

(54) Milling cutter

(75) Inventor: Rafael Morgulis, Karmiel (IL)

Correspondence Address: AKERMAN SENTERFITT, P.O. BOX 3188, WEST PALM BEACH, FL, 33402-3188, US

(73) Assignee: Vargus Ltd., Nathariya (IL)

(21) Appl. No.: 11/216,983

(22) Filed: Aug. 31, 2005

(30) Foreign Application Priority Data
Sep. 2, 2004 (DE) 102004043409

(51) Int. Cl. B23C 5/20

(52) U.S. Cl. 407/33; 407/113; 409/65

(57) ABSTRACT

The thread cutter has a tool holder with a fixing shank and a cutter shank. In the same are inserted cutting inserts with cutting edges having a thread cutting profiling. They are retained by clamping screws inserted in tapped holes. The clamping screws act at right angles on the mutually parallel sides of the cutting inserts. The in each case three tapped holes in the cutter shank are so displaced relative to one another that in each case there is only one tapped hole in a radial plane of the cutter shank.

The following disclosure is based on German Patent Application No. 10 2004 043 409.3 filed on Sep. 2, 2004, which is herewith incorporated into this application by explicit reference.

### FIELD OF APPLICATION AND PRIOR ART

The invention relates to a cutting tool, particularly a thread cutter.

U.S. Pat. No. 6,499,917 B1 discloses a thread cutter having a tool holder rotatable about a tool axis and several cutting inserts fittable thereto. In slot-like recesses uniformly distributed over the tool circumference and running essentially in the tool axial direction can be inserted cutting inserts having an elongated ledge shape and with as cutting edges a thread profiling. They can be fixed in the recesses by clamping screws acting on one side of the cutting insert. The clamping screws run under an acute angle to the cutting insert median plane and their end faces encounter in flat manner sloping depressions in the sides of the cutting insert. This aims at producing a force which presses the cutting insert into the recess.

In other thread cutters (U.S. Pat. Nos. 5,924,825, 5,059,070, 5,088,861 and 4,425,063) cutting inserts are fixed by screws passing through said inserts. In the construction according to U.S. Pat. Nos. 5,873,684 and 5,112,162 positive fixing elements in the form of pins or clamping wedges are used for fixing the inserts.

### OBJECT AND SOLUTION

The object of the invention is to provide a cutting tool and a cutting insert for the same, which in conjunction with the tool holder can be easily and securely fixed and in such a way as to aid the rigidity and strength of the overall system.

This object is met by the independent claims.

Due to the fact that corresponding tapped holes for adjacent recesses or cutting inserts inserted therein are displaced relative to one another in the tool axial direction, it is possible to ensure that on equipping with several cutting inserts the tool holder is not weakened as a result of several tapped holes all being located in the same radial plane. Thus, with the arrangement according to the invention, it is also possible to provide smaller diameter tool holders, i.e. for small holes, with adequately large clamping screws. The angle between the median plane of the recesses, i.e. also the cutting inserts, and the tapped hole axes is in optimum manner a right angle and the clamping screws and cutting inserts should be constructed in such a way that they act substantially at right angles on the cutting inserts. Thus, the latter are secured in their inserted position solely by clamping and not by positive engagement. This has the advantage that there are certain setting possibilities with respect to the diameter and orientation. Thus, the cutting insert can, but need not engage with its end face on the bottom of the recess.

Normally there are three clamping screws per cutting insert and the two outer screws act on the smooth, unrecessed side of the cutting insert. The central clamping screw acts on the bottom of a flat depression, e.g. a circular cavity. The active end of the clamping screw is so constructed, e.g. by a projection, that although it rests on the bottom of the depression, it is not in contact with it circumferential edge, i.e. leaving setting possibilities in all directions. However, through the penetration of the depression, said clamping screw secures against unintentional dropping or skidding out under centrifugal force if e.g. as a result of an error during insertion the screws are not tightened. Thus, said depression provides an additional securing effect, which ensures for a positive securing action without restricting the other possibilities.

In order in the case of the displacement of the clamping screws provided to have a need for only a single type of cutting inserts for all the recesses on the circumference of a tool holder, there are on each side of the cutting insert the same number of depressions as there are displacement possibilities, i.e. corresponding to the number of cutting inserts of the tool holder. However, the depressions could also be combined into a recessed surface, e.g. a type of elongated hole, provided that there is an elevation towards the end face ensuring the positive securing action. However, individual cavities can be produced more easily and also longitudinally secure the inserts.

As the cutting inserts are preferably turnover plates, i.e. the profile cutting edge can be inserted from both sides, the depression are also provided on both sides.

These and further features can be gathered from the claims, description and drawings and the individual features, both singly and in the form of subcombination, can be implemented in an embodiment of the invention and in other field and can represent advantageous, independently protectable constructions for which protection is claimed here. The subdivision of the application into individual section and the subheadings in no way restricts the general validity of the statements made thereunder.

### BRIEF DESCRIPTION OF THE DRAWINGS

An embodiment of the invention is described in greater detail hereinafter relative to the drawings, wherein show:

FIG. 1A perspective view of a cutting tool according to the invention.

FIG. 2A side view of the cutting tool.

FIG. 3A detail, sectioned along line III-III of FIG. 2.

FIGS. 4a to 4c Three perspective views in each case rotated by 120ø of the cutting inserts and their clamping screws in the cutting tools according to FIGS. 1 and 2 (in each case without tool holder).

FIG. 5A perspective view of a cutting tool equipped with two cutting inserts.

FIG. 6A plan view of the cutting tool according to FIG. 5.

FIG. 7A section along line VII-VII in FIG. 6.

### DESCRIPTION OF EMBODIMENTS

FIGS. 1 to 4 show a cutting tool 11 with a tool holder 12, which is provided with a larger diameter fixing shank 13 and a somewhat smaller diameter cutter shank 14. In the latter are fixed three cutting inserts 15 using clamping screws 16, which are screwed into tapped holes 17 in the cutter shank.

The cutting inserts 15 are located in recesses 18, constructed in the manner of rectangular slots, which extend along the cutter shank and parallel to the tool central axis 19. Their median planes 20, which are parallel to those of the cutting inserts and almost coincide therewith, run radially and parallel to the axis 19.

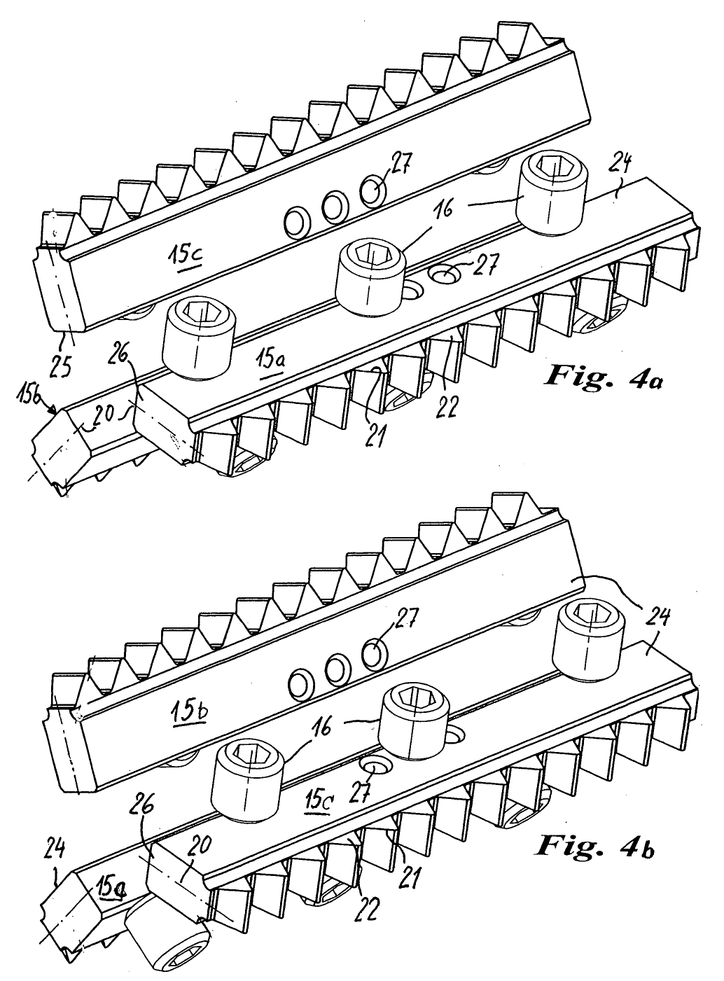

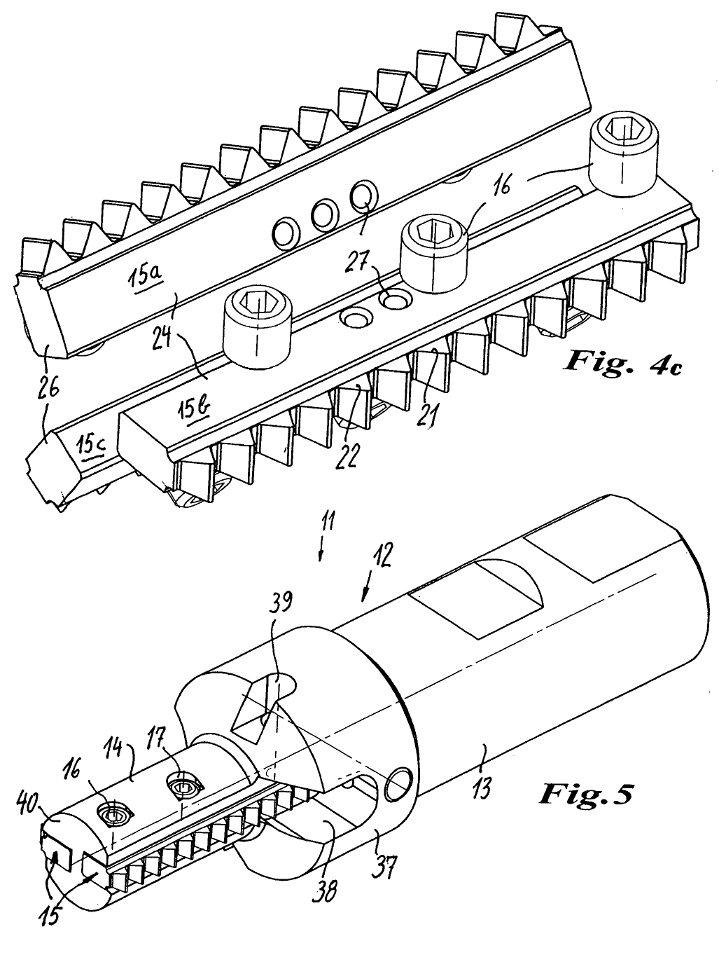

The cutting inserts 15, which can best be seen in FIGS. 4a to 4c, are shaped like elongated ledges provided on one longitudinal side with cutting edges 21 with a toothed profiling for thread cutting purposes. The cutting edges are symmetrical about the median plane 20, so that there are cutting edges 21 on both sides. Thus, the cutting insert can be used twice by turning by 180ø. Thus, on both sides is ground a corresponding sloping rake face 22 for a suitable cutting rake and a chip breaker shoulder 23 connected thereto.

The cutting insert also has substantially planar, mutually parallel sides 24 and an end face 25 opposite to the cutting edges, together with front faces 26 at the ends of its ledge shape.

In the centre of the longitudinal extension of the sides 24 and symmetrical to the centre, but spaced from one another, there are three depressions 27 on each side. They are in the form of cavities with a planar bottom (cf. FIG. 3), provided relatively close to the rear edge of the sides pointing towards the end face.

The cutting inserts are largely made from hard metal or other hard materials, which can usually only be worked by sintering or grinding. The elongated, flat, ledge-like shape of the cutting inserts permits rational manufacture.

FIG. 3 shows on much larger scale a section through the central clamping screw 16 and cutting insert 15 in the fixed state. It can be seen that the recess 18 has a width adapted to the thickness of the cutting insert 15 and is cut substantially radially in the cutter shank 14. The lower side 24 of the cutting insert in the drawing engages on the corresponding face of the cutting insert and its end face 25 is on the base of the recess.

The recess is crossed by a hole 29, whose axis 30 is at right angles on the central axis-representing median plane of the recess 18 and cutting insert 15. In its part facing its opening, the hole 29 is constructed as a tapped hole 17 into which is screwed the clamping screw 16. The latter is a headless grub screw with an internal key face, e.g. a hexagonal recess 31. At its end facing the cutting insert 15 it is provided with a smaller diameter projection 32, whose end face 33 is located in one of the depressions 27 and namely on the bottom 34 thereof, which is parallel to the sides 24 and therefore to the median plane 20.

It is clear that it is possible to use a relatively large and strong clamping screw, which is advantageous in view of the in part very small dimensions of the cutting tool. With its projection 32 in depression 27 the clamping screw 16 acts on the cutting insert and presses it with the lower side 24 in FIG. 3 onto the side wall of the recess 18, but without exerting a force in the direction of the median plane 20 on the cutting insert. The sloping sides of the projection 32 do not cooperate with the edges 35 of the depression when the cutting insert is correctly fixed. On loosening said clamping screw and also the two other clamping screws which, as can be seen in FIGS. 4a to 4c, act on the smooth lateral faces 24, the elevation 36 bounding the depression 27 towards end face 25 would secure the cutting insert against dropping out until the central clamping screw 16 had been unscrewed to such an extent that the projection 32 was completely freed from the depression.

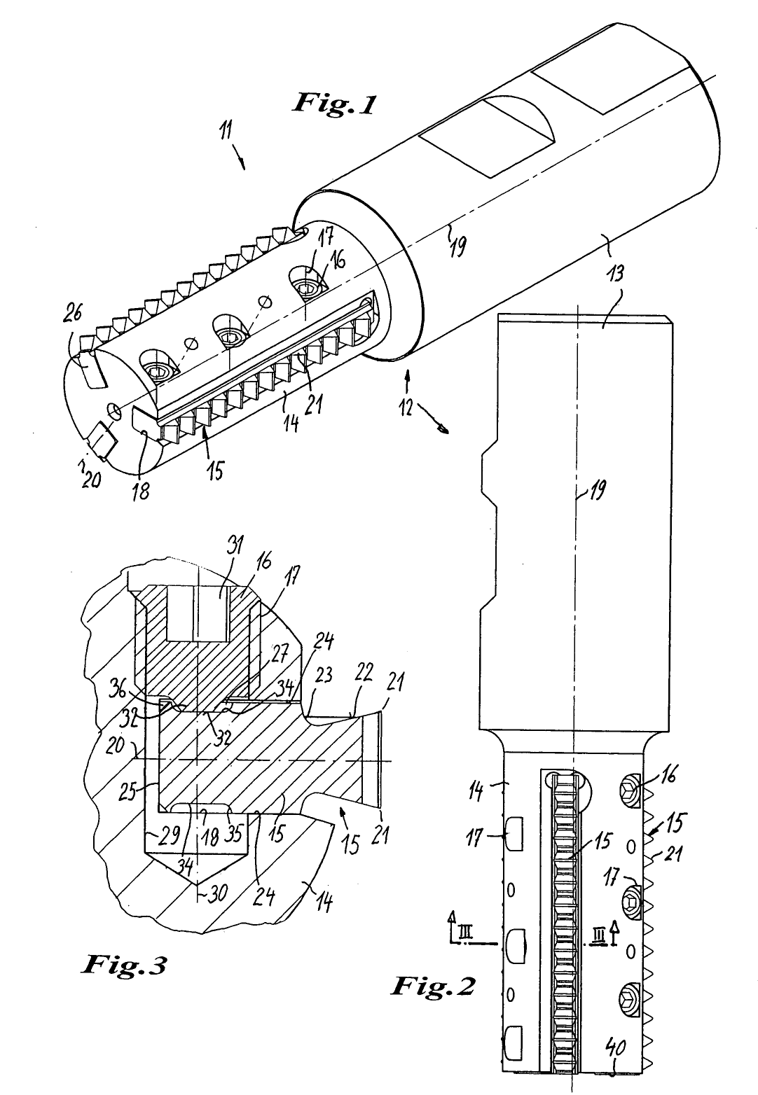

It can be seen in FIG. 2 and also FIGS. 4a to 4c that the tapped holes 17 of clamping screw 16 are so displaced relative to one another in the longitudinal direction of the cutting tool 11, i.e. along the tool central axis 19, that in each case there is only one tapped hole weakening the cutter shank on each radial plane.

In order to demonstrate this, in FIGS. 4a to 4c the identical inserts 15 are followed by the letters a to c. It can be seen that in the case of insert 15a the clamping screws act furthest to or from the left and correspondingly the central clamping screw 16 engages in the furthest left depression 27, whereas with insert 15b (FIG. 4b) this is in each case a central position and in the case of insert 15c (best seen in FIG. 4c) the clamping screws in each case act on the furthest right side. Thus, the displacement or offset corresponds to the longitudinal, mutual spacing of the depressions 27 and should preferably be at least as large as the diameter of the tapped holes 17.

It is therefore clear that despite the usability of relatively large and strong clamping screws with an inner key face (hexagonal recess, hexagonal socket head, etc.) the cutter shank and therefore the overall dimensions can be relatively small and therefore the both highly vibration and strength-stressed cutter shank remains without any significant structural weakening. This is particularly important for thread cutters for cutting internal threads, whose overall diameter must be smaller than that of the tapped hole to be machined.

FIG. 5 shows a construction with only two cutting inserts 15. The construction is otherwise identical to that according to FIGS. 1 to 4 with the difference that the tool holder 12 is provided between the fixing shank 13 and the cutter shank 14 with a thickened portion 37 having cutouts 38 into which projects part of the fixing shank and is covered there. The tapped hole of one of the clamping screws is located in a further cutout 39. This construction is provided for the provision of longer cutting inserts 15 for only short threads, whilst further increasing the rigidity of the overall tool.

FIG. 6 shows in plan view the tool of FIG. 5. As in FIG. 2 it can be seen that the spacing between the in each case front clamping screw facing the free end 40 of the cutting tool 11 and the central clamping screw engaging in depression 27 is smaller than the spacing to the clamping screw furthest away from end face 40. This takes account of the greater stressing and vibration sensitivity of the tool close to its free end 40.

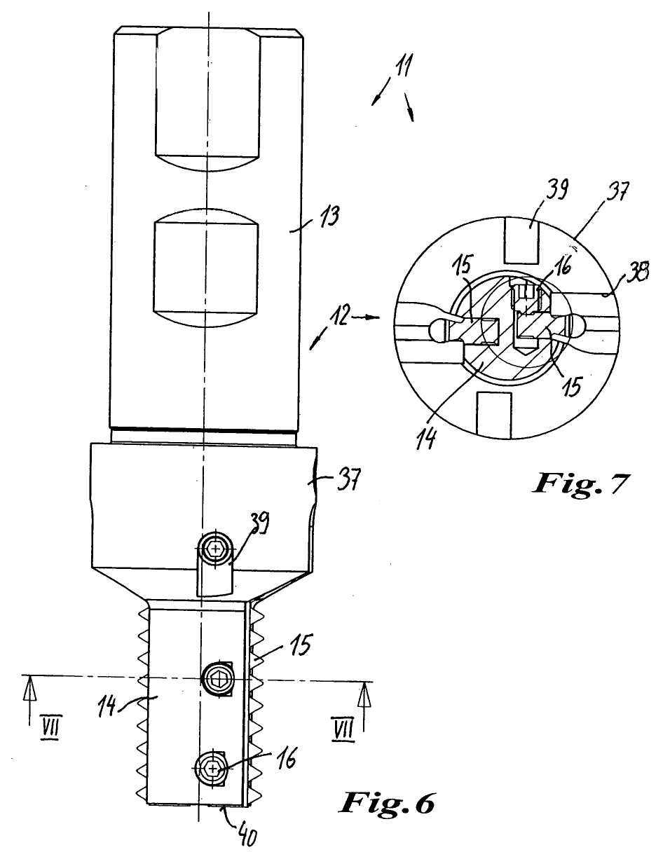

FIG. 7 shows in section the arrangement already described in detail relative to FIG. 3 and clearly illustrates that through the omission of the clamping screw for the left cutting insert 15 in the represented plane the cutter shank cross-section is much larger than with an undisplaced arrangement.

The constructions and dimensions of the cutting tool and cutting insert shown in the drawings are particularly advantageous and express reference is made to the drawings for disclosure purposes.

1. Cutting tool comprising:
a tool holder rotatable about a tool axis
several cutting inserts fittable thereto, having at least one cutting edge, two sides, an end face and two front faces
which inserts can be inserted in slot-like recesses of the tool holder distributed over the tool holder circumference and oriented substantially in the tool axial direction
said inserts being fixable by clamping screws acting on one side of the cutting insert which are screwed into tapped holes, which are oriented under an angle to the median plane of the recesses,
corresponding tapped holes for adjacent recesses being displaced relative to one another in the direction of the tool axis.

2. Cutting tool according to claim 1, wherein the angle is a right angle.

3. Cutting tool according to claim 1, wherein the clamping screws act substantially at right angles on one of said sides of cutting insert, this side and also the other of said sides are parallel to one another and to the median plane of the cutting insert.

4. Cutting tool according to claim 1, wherein at least one of the clamping screws, cooperates with a shallow depression in the cutting insert side, whose bottom forms a surface parallel to the lateral and median plane, the depression, at least towards the end face, being bounded by an elevation projecting over the bottom.

5. Cutting tool according to claim 4, wherein the clamping screw cooperation with said shallow depression is positioned axially between two other screws.

6. Cutting tool according to claim 4, wherein the depression is a circular cavity.

7. Cutting tool according to claim 4, wherein at least two juxtaposed depressions are provided in at least one side of the cutting insert and cooperate with correspondingly axially displaced clamping screws.

8. Cutting tool according to one of the claims 4, wherein there are the same number of depressions in one side as there are cutting inserts per cutting tool.

9. Cutting tool according to claim 1, wherein the cutting inserts are in the form of elongated ledges, which carry as the cutting edge a thread cutting profile.

10. Cutting tool according to claim 1, wherein the cutting inserts or are constructed as turnover plates.

11. Cutting tool according to claim 1, wherein for each recess are provided a central clamping screw and in each case two other clamping screws engaging closer to the front faces.

12. Cutting tool according to claim 1, wherein the clamping screws have on their end face engaging on the cutting insert a projection forming a clamping face.

13. Cutting tool according to claim 1, wherein the displacement is of the same order of magnitude as the diameter of the tapped holes.

14. Cutting insert for a cutting tool, for inserting in a tool holder rotatable about a tool axis and insertable in slot-like recesses of the tool holder distributed over the tool holder circumference and running substantially in the tool axial direction and fixable by clamping screws acting on one side of the cutting insert and which are screwed into the tapped holes, which are directed under a right angle to the median plane of the recesses and in which the cutting inserts are ledge-shaped with a cutting edge and having depressions for clamping screws on one of their sides, wherein in a central area of the cutting insert length is provided at least one depression in the form of a cavity and whose substantially planar bottom running parallel to the median plane of the cutting insert is larger than the end face of the clamping screw associated therewith.

15. Cutting insert according to claim 12, wherein there are several juxtaposed depressions.
